(19) United States
(12) Patent Application Publication
(10) Pub. No.: US 2024/0159411 A1
(43) Pub. Date: May 16, 2024

(54) HEAT RECOVERY VENTILATION SYSTEM WITH DEFROSTING BYPASS

(71) Applicant: ZEHNDER GROUP INTERNATIONAL AG, CH-5722 GRÄNICHEN (CH)

(72) Inventors: Paolo MASETTI, Modena (IT); Danilo PIZZONI, Modena (IT)

(73) Assignee: ZEHNDER GROUP INTERNATIONAL AG, CH-5722 GRÄNICHEN (CH)

(21) Appl. No.: 18/279,924

(22) PCT Filed: Mar. 10, 2022
(86) PCT No.: PCT/EP2022/056240

§ 371 Date: Sep. 1, 2023

(30) Foreign Application Priority Data
Mar. 19, 2021 (CH) 00300/21

(51) Int. Cl. F24F 11/43; F24F 12/00

(52) U.S. Cl. CPC F24F 11/43; F24F 12/003; F24F 2012/007

(57) ABSTRACT

Disclosed herein is a heat recovery ventilation system (1) for a building comprising a heat recovery ventilation unit (10) with a heat exchanger (11), a supply air channel (20) being in fluidic connection with a supply air outlet (14) and being configured for delivering supply air from the heat exchanger (11) to the inside of the building; a return air channel (21) being in fluidic communication with the return air inlet (15) and being configured for delivering return air from the inside of the building to the heat exchanger (11); an exhaust air channel (22) being in fluidic communication with an exhaust air outlet (16) and being configured for delivering exhaust air from the heat exchanger (11) to the outside of the building; an outside air channel (23) being in fluidic communication with an outside air inlet (17) and being configured for delivering outside air to the heat exchanger (11) and an air source heat pump.

### BACKGROUND OF THE INVENTION

### Field of the Invention

The present invention lies in the field of building ventilation, heating and cooling and relates to a heat recovery ventilation system, a method of operating such a system as well as the use of such a system.

### Discussion of Related Art

Heat recovery ventilation systems with heat recovery ventilation units are known in the field of ventilation systems for buildings. Such units comprise a heat exchanger which allows for exchange of thermal energy between fresh air from the outside and return air from the inside. The advantage of these units is that in winter, thermal energy can be transferred from exhaust air, i.e., air coming from inside the building, to incoming fresh air, i.e., air coming from outside the building, thereby decreasing the overall energy consumption of the building.

It is also known to combine such heat recovery ventilation units with air source heat pumps. Such heat pumps transfer thermal energy, i.e., heat, from the exhaust air, which would otherwise be emitted unused to the outside, to the supply air which is delivered into the building. This allows to heat or cool the incoming supply air in particular during winter season. As commonly known, such heat pumps generally contain a cyclic, i.e., circuit and closed loop, pipe system comprising a suitable refrigerant, for example propane, butane, pentane, chlorofluorocarbons, hydrochlorofluorocarbons, hydrofluorocarbons and the like, a compressor, a condenser, an evaporator and an expansion valve.

### SUMMARY OF THE INVENTION

An often observed problem with heat recovery ventilation systems that combine heat recovery ventilation units and air source heat pumps is that during cold periods, the evaporator tends to work at evaporating temperatures of below 0° C. As the exhaust air typically contains moisture, the evaporator freezes on its outside surface and may thereby impede air flow through the condenser and must therefore periodically be defrosted.

Defrosting may for example be done by switching off the air source heat pump for a certain period of time until the evaporator is defrosted. In order to decrease the defrosting time, external heaters can be arranged around the evaporator. This has however the disadvantage of added complexity, increased energy demand and higher costs.

Alternatively, defrosting can be achieved by a four-way valve, which enables to reverse the cycle of the air source heat pump. In such an approach, the roles of the evaporator and the condenser are reversed during the defrosting mode, i.e., the reversed mode. The four-way valve is switched such that in the original condenser, i.e., the element in which in the normal operational state, the refrigerant transfers energy to the supply air, thereby undergoing a condensation, becomes the evaporator, in which the refrigerant takes up thermal energy from the supply air, thereby undergoing an evaporation. The evaporated refrigerant is then compressed and delivered to the frozen original evaporator, which due to the cycle reversal became the condenser in the defrosting mode. The refrigerant condenses thereby releasing thermal energy, which causes defrosting of the original evaporator.

The advantage of this approach is that defrosting is faster as compared to a mere shut down of the air source heat pump and that no complicated and expensive additional heaters are necessary. The problem associated therewith however is that due to the reversal of the air source heat pump cycle, the original condenser becomes the evaporator in the defrosting mode and thus thermal energy is withdrawn from the supply air before it is being delivered to the inside of the building. In particular, during cold periods, this is disadvantageous, as the cold air stream is uncomfortable for the habitants. Furthermore, the inside of the building is cooled down, which is in many cases compensated by other heating elements and thus adversely affects the overall energy balance.

In order to reduce cold supply air flow, the fans of the heat recovery ventilation system, in particular the fans of the heat recovery ventilation unit can be switched off during in the defrosting mode. However, there is no delivery of fresh air at this moment. Furthermore, such an approach ceases the ventilation, which may be particularly disadvantageous during cooking, showering and the like. An additional disadvantage is that switching off and on the fans leads to increased noise emissions, which is uncomfortable for the habitants.

It is therefore an overall object of the present invention to further develop the state of the art of heat recovery ventilation systems, and preferably overcoming the disadvantages of the prior art fully or partly. In some advantageous embodiments, a particular energy efficient heat recovery ventilation system and an energy efficient method for operating such a system is provided. In some advantageous embodiments, a heat recovery ventilation system is provided whose evaporator can be particularly fast defrosted, as well as a method according to which an evaporator of a heat recovery ventilation system can be defrosted particularly fast.

The overall objective is achieved by a heat recovery ventilation system and a method of operating a heat recovery system according to the independent claims. Further advantageous embodiments follow from the dependent claims, as well as the description and the drawings.

The first aspect of the invention concerns a heat recovery ventilation system for a building comprising: a heat recovery ventilation unit comprising a unit housing having a supply air outlet, a return air inlet, an exhaust air outlet and an outside air inlet. The unit housing defines a unit compartment, wherein a heat exchanger is arranged within the unit compartment. The heat exchanger is further configured such that thermal energy and optionally latent energy can be exchanged between outside air being delivered via the outside air inlet and return air being delivered via the return air inlet. The heat recovery ventilation system further comprises a supply air channel being in fluidic connection with the supply air outlet and being configured for delivering supply air from the heat exchanger to the inside of the building, a return air channel being in fluidic communication with the return air inlet and being configured for delivering return air from the inside of the building to the heat exchanger, an exhaust air channel being in fluidic communication with the exhaust air outlet and being configured for delivering exhaust air from the heat exchanger to the outside of the building, an outside air channel being in fluidic communication with the outside air inlet and being configured for delivering outside air to the heat exchanger. The heat recovery ventilation system further comprises an air source heat pump comprising an evaporator being configured for exchanging thermal energy with exhaust air in the exhaust air channel, a condenser being configured for exchanging thermal energy with supply air in the supply air channel, a compressor, an expansion valve and a four-way valve being configured for reversing the cycle of the air source heat pump from a normal mode, i.e., heating mode, to a defrosting mode. The exhaust air channel comprises an evaporator bypass, which bypasses the evaporator, and an exhaust air channel bypass valve being switchable between an open position and a closed position. In the open position exhaust air can flow through the evaporator bypass and the exchange of thermal energy between exhaust air and the evaporator is prevented. In contrast, in the closed position exhaust air flow through the evaporator bypass is prevented and the exchange of thermal energy between exhaust air and the evaporator is possible, respectively enabled. Furthermore, the supply air channel comprises a condenser bypass, which bypasses the condenser and a supply air channel bypass valve being switchable between an open position and a closed position. In the open position supply air can flow through the condenser bypass and the exchange of thermal energy between supply air and the condenser is prevented. In contrast, in the closed position supply air flow through the condenser bypass is prevented and the exchange of thermal energy between supply air and the condenser is possible, respectively enabled.

The advantage of such a heat recovery ventilation system is that the four-way valve enables to reverse the cycle of the air source heat pump, i.e., the roles of the evaporator and the condenser are reversed, respectively exchanged, during the defrosting mode, i.e., the reversed mode. Additionally, however the exhaust air channel bypass valve and the supply air channel bypass valve can be brought in an open position, which causes the air to bypass the original evaporator and the original condenser. This allows for fast defrosting of the original evaporator by reversing the cycle of the air source heat pump, and concomitantly prevents that the supply air passes the original condenser, which in the defrosting mode acts as evaporator, which largely prevents direct withdrawal of thermal energy from the supply air. Therefore, efficient, i.e., fast and simple, defrosting is possible without delivering cold supply air to the building.

It is understood that the normal mode refers to the heating mode of the heat recovery ventilation system. The terms “original condenser” and “original evaporator” refer to the elements acting as condenser, respectively as evaporator, in the normal mode. The terms “condenser” and evaporator” as used herein refer to the corresponding elements in the normal mode, unless stated otherwise. In the normal mode, the refrigerant condenses in the condenser, thereby transferring thermal energy to the supply air. The condensed refrigerant may then pass an expansion valve and is then delivered to the evaporator in which it takes up thermal energy from the exhaust air under evaporation. The evaporated refrigerant is then delivered to a compressor, which compresses the refrigerant and then the compressed refrigerant is fed back to the condenser. It is further understood that the terms “heat recovery unit” and heat recovery ventilation unit” are used interchangeably herein for the same unit.

Vice versa, the defrosting mode refers to the reversed mode, i.e., the operational mode in which the four-way valve is switched and the direction of flow is typically reversed with respect to the normal mode. The original evaporator becomes in the defrosting mode, respectively acts as, the defrosting mode condenser, and the original condenser becomes in the defrosting mode, respectively acts as, the defrosting mode evaporator.

The heat recovery ventilation unit may in some embodiments comprise a fresh air fan, such as a fresh air centrifugal fan arrangement, configured for transporting fresh air from the outside air inlet to the supply air outlet, and an exhaust air fan, such as an exhaust air centrifugal fan arrangement, configured for transporting exhaust air from return air inlet to the exhaust air outlet.

In some embodiments, the heat exchanger comprises fresh air flow passages for a fresh air flow, wherein the fresh air flow passages are in fluid communication with, particularly only with, the supply air outlet and the outside air inlet of the unit housing. The heat exchanger further comprises in such embodiments exhaust air flow passages for an exhaust air flow, wherein the exhaust air flow passages are in fluidic communication with, particularly only with, the return air inlet and the exhaust air outlet. The fresh air flow passages and the exhaust air flow passages are configured such that thermal energy and optionally latent energy can be exchanged between the fresh air flow and the exhaust air flow.

Typically, the heat recovery ventilation unit is configured such that the incoming outside air and the exiting supply air are fluidic separated from the incoming return air and the exiting exhaust air. This may for example be achieved by a suitable channel system within the heat recovery ventilation unit.

It is understood that the air source heat pump comprises a heat pump pipe system, which contains and guides a refrigerant. For example, the refrigerant may be a suitable hydrocarbon, i.e., propane, butane, pentane, or suitable halogenated hydrocarbons, such as chlorofluorocarbons, hydrochlorofluorocarbons or hydrofluorocarbons. The air source heat pump comprises an evaporator, preferably having an evaporator coil, and a condenser, preferably having a condenser coil. The evaporator is arranged such that thermal energy can be exchanged with the exhaust air in the exhaust air channel. The condenser is arranged such that thermal energy can be exchanged with the supply air. The air source heat pump may comprise an expansion valve being arranged between the condenser and the evaporator, particularly upstream of the evaporator and downstream of the condenser. The air source heat pump may comprise a compressor being arranged between the condenser and the evaporator, particularly downstream of the evaporator and upstream of the condenser.

Typically, in the closed position of the exhaust air channel bypass valve and of the supply air channel bypass valve, exhaust air may only flow to the outside of the building via the evaporator bypass and supply air may only flow to the inside of the building via the condenser bypass. In other words, in the corresponding open position, exhaust air is prevented from directly passing, i.e., contacting, the evaporator, respectively, supply air is prevented from directly passing, i.e., contacting, the condenser.

In some embodiments, the outside air channel and the exhaust air channel are fluidic connected, particularly directly fluidic connected, with each other by a support channel comprising a support fan and being configured for delivering a portion of outside air directly to the exhaust air channel. Such embodiments are advantageous, as due to the increased air flow of cold outside air towards the evaporator, the performance of the air source pressure pump is increased.

In certain embodiments, the support channel is connected with the exhaust air channel upstream of the evaporator and optionally downstream of the exhaust air channel bypass valve.

In some embodiments, the support channel comprises a support channel valve being switchable between an open position in which outside air can flow from the outside air channel through the support channel into the exhaust air channel and a closed position in which outside air is prevented from flowing from the outside air channel through the support channel into the exhaust air channel. Such embodiments are beneficial, as it increases the defrosting speed of the original evaporator, i.e., the defrosting mode condenser, because the delivery of cold outside air towards it can be prevented in the defrosting mode.

In some embodiments, the heat recovery ventilation system additionally comprises a sensor or a plurality of sensors, particularly a temperature and/or pressure sensor, configured for monitoring a status of the evaporator. For example, the sensor may be a temperature sensor measuring the temperature of the refrigerant in the evaporator. It may also be possible that the sensor is a temperature sensor being configured to measure the surface temperature of the evaporator, particularly of the evaporator coil. It may also be possible that the sensor is a pressure sensor configured for measuring the pressure of the refrigerant, particular in the or downstream of the evaporator. It may further be possible that the sensor is an optical sensor, such as a camera configured for monitoring the state of the evaporator, in particular ice formation. The status of the evaporator may typically be related to a parameter allowing to determine if defrosting is necessary. It may however also be possible that the sensor only indirectly monitors the status of the evaporator, i.e., by measuring the temperature of the refrigerant upstream of or in the condenser. As mentioned above, this may be a pressure, a temperature or an optical parameter, or a combination thereof. Such a sensor or such sensors are beneficial, because they allow the user to determine whether defrosting should be conducted or not.

In some embodiments, the heat recovery ventilation system further comprises a control unit. Such a control unit may for example be configured to trigger an alarm if the sensor indicates that defrosting of the evaporator is necessary or advisable.

The control unit may typically comprise a circuit and/or a microprocessor.

In some embodiments, the control unit is configured for receiving an input parameter of the sensor, for comparing the input parameter with a predefined threshold value and if the input parameter deviates from, i.e., falls below, or depending on the parameter exceeds, the predefined threshold value, for switching the four-way valve into the defrosting mode in order to reverse the cycle of the air source heat pump and for switching the exhaust air channel bypass valve and the supply air channel bypass valve from the closed position into their corresponding open position. Such embodiments are particularly advantageous, as the defrosting process can be fully automated. The predefined threshold values may for example be a threshold temperature. If the input parameter, i.e., the measured temperature of the sensor falls below the threshold temperature, the control unit may switch the four-way valve into the defrosting mode and switch both the exhaust air channel bypass valve and the supply air channel bypass valve from their corresponding closed position into the corresponding open position. It is understood that the same principle may apply for a threshold pressure or a threshold optical parameter, such as a predefined amount of ice formation, etc.

If the heat recovery ventilation system comprises a support channel and a support channel valve, the control unit may also be configured to concomitantly switch the support channel valve from the open position into the closed position if the input parameter deviates from, i.e., falls below or exceeds the predefined threshold value.

The control unit may be configured for continuously or periodically receiving and comparing the input parameter of the sensor.

In some embodiments, the control unit may be modifiable by the user such that the defrosting mode cannot be activated either on demand or during predefinable periods of the day, for example during the night, for example from 10 pm to 6 am.

In some embodiments, the control unit is further configured for comparing the input parameter with a predefined target value and if the input parameter is equal to or above, or below the predefined target value, for switching the four-way valve in order to reverse the cycle of the air source heat pump into the normal mode and for switching the exhaust air channel bypass valve and the supply air channel bypass valve from the open position into the closed position. Thus, if the control unit determines due to the input parameter that defrosting of the evaporator is complete, the system changes automatically from defrosting mode back to the heating mode, i.e., the original mode.

If the heat recovery ventilation system comprises a support channel and a support channel valve, the control unit may also be configured to concomitantly switch the support channel valve from the open position into the closed position if the input parameter is equal to or above, or below the predefined target value. The target value may in some embodiments be identical to the threshold value, however it may in other embodiments also be higher or lower than the threshold value. Typically, the target value and the threshold value refer to the same parameter type.

The condenser bypass may typically branch off of the supply air channel upstream of the condenser and reconnect with the supply air channel downstream of the condenser.

The evaporator bypass may typically branch off of the exhaust air channel upstream of the evaporator and reconnect with the exhaust air channel downstream of the evaporator.

The exhaust air channel bypass valve and the supply air channel bypass valve may in some embodiments be two way valves in which always only a single airflow path, i.e., either through the condenser bypass or via the condenser, respectively either through the evaporator bypass or via the evaporator, is open for the supply air, respectively the exhaust air, while the corresponding other path, i.e., via the condenser or through the condenser bypass, respectively either via the evaporator or through the evaporator bypass, is closed. For example, the exhaust air channel bypass valve and the supply air channel bypass valve may be pivotable flap valves. Alternatively, each of the exhaust air channel bypass valve and the supply air channel bypass valve may each comprise two separate valve elements which can be switched into an open position in which the air can flow through the respective path and a closed position in which the respective path is blocked for airflows. In this case, it can either be manually or via the control unit be secured that always one corresponding flow path is open (for example via the condenser or via the evaporator), while the other one is closed (for example through the condenser bypass or through the condenser bypass).

In some embodiments, the invention relates to a building comprising a heat recovery ventilation system according to any of the embodiments described herein.

In a second aspect the invention concerns a method for operating a heat recovery ventilation system for a building, in particular a heat recovery ventilation system according to any of the embodiments described herein, the method comprising the steps:
a. Operating the heat recovery ventilation system in a heating mode, the heating mode comprising:
   Providing outside air from the outside of the building via an outside air channel to a heat exchanger being arranged in a unit compartment defined by a unit housing of a heat recovery ventilation unit through an outside air inlet of the unit housing;
   Providing return air from the inside of the building via a return air channel to the heat exchanger through a return air inlet of the unit housing;
   Transferring thermal energy and optionally latent energy from the return air to the outside air, thereby transforming the return air into exhaust air with decreased thermal energy and optionally latent energy as compared to the return air and transforming the outside air into supply air with an increased thermal energy and optionally latent energy as compared to the outside air;
   Delivering the exhaust air from the heat exchanger through an exhaust air outlet of the unit housing through an exhaust air channel to the outside of the building, wherein thermal energy is transferred from the exhaust air to a refrigerant being arranged within an evaporator of an air source heat pump, thereby evaporating the refrigerant;
   Compressing the evaporated refrigerant in a compressor of the air source heat pump;
   Delivering the supply air from the heat exchanger through a supply air outlet of the unit housing through a supply air channel to the inside of building, wherein thermal energy is transferred from the compressed refrigerant within a condenser of the air source heat pump to the supply air, thereby condensing the refrigerant;
b. Switching the heat recovery ventilation system from the heating mode to a defrosting mode by switching a four-way valve of the air source heat pump into the defrosting mode in order to reverse the cycle of the air source heat pump, and by switching an exhaust air channel bypass valve of the exhaust air channel and a supply air channel bypass valve of the supply air channel each into the corresponding open position; and
c. Operating the heat recovery ventilation system in the defrosting mode, the defrosting mode comprising:
   Providing outside air from the outside of the building via the outside air channel to the heat exchanger through the outside air inlet of the unit housing;
   Providing return air from the inside of the building via the return air channel to the heat exchanger through the return air inlet of the unit housing;
   Transferring thermal energy and optionally latent energy from the return air to the outside air, thereby transforming the return air into exhaust air with decreased thermal energy and optionally latent energy as compared to the return air and transforming the outside air into supply air with an increased thermal energy and optionally latent energy as compared to the outside air;
   Delivering the supply air from the heat exchanger through the supply air outlet of the unit housing through the supply air channel and through the condenser bypass bypassing the condenser to the inside of building;
   Delivering the exhaust air from the heat exchanger through the exhaust air outlet of the unit housing through the exhaust air channel and through the evaporator bypass bypassing the evaporator to the outside of the building; and
   Defrosting the evaporator.

It is understood that the embodiments and definitions described for any of the embodiment of the first aspect of the invention are also applicable for the method according to the second aspect of the invention.

It is understood that in the open position of the exhaust air channel bypass valve exhaust air can flow through the evaporator bypass and the exchange of thermal energy between exhaust air and the evaporator is prevented. In contrast, in the closed position exhaust air flow through the evaporator bypass is prevented and the exchange of thermal energy between exhaust air and the evaporator is possible, respectively enabled.

It is further understood that in the open position of the supply air channel bypass valve supply air can flow through the condenser bypass and the exchange of thermal energy between supply air and the condenser is prevented. In contrast, in the closed position supply air flow through the condenser bypass is prevented and the exchange of thermal energy between supply air and the condenser is possible, respectively enabled.

In some embodiments, a sensor, particularly a temperature and/or pressure sensor, monitors, particularly continuously or periodically, a status of the evaporator and provides a corresponding input parameter to a control unit, wherein the control unit compares the input parameter with a predefined threshold value and wherein step b. is effected by the control unit if the input parameter deviates from, i.e., falls below or exceeds the predefined threshold value.

In some embodiments in which the sensor periodically monitors the status of the evaporator, the periods may be divided into regular intervals, for example every 1 s, every 5 s, every 10 s, every 30 s, every 60 s, every 5 min, every 10 min, every 30 min, every 60 min, every 2 h, every 6 h every 12 h or every 24 h.

In some embodiments, the control unit switches the four-way valve into the normal mode in order to reverse the cycle of the air source heat pump and switches the exhaust air channel bypass valve and the supply air channel bypass valve from their corresponding open position into their corresponding closed position, if the input parameter is equal to or above or below a predefined target value.

In some embodiments, during step a. a portion of the outside air is delivered directly to the exhaust air channel via a support channel comprising a support fan.

In some embodiments, during step b. a support channel valve is switched from the open position to the closed position, thereby preventing outside air from flowing from the outside air channel through the support channel into the exhaust air channel. In particular, this may be effected by the control unit if the input parameter deviates from, i.e., falls below or exceeds the predefined threshold value.

In a third aspect the invention concerns the use of a heat recovery ventilation system according to any of the embodiments of the first aspect of the invention for heating and/or cooling a building, and/or for providing outside air into a building.

### BRIEF DESCRIPTION OF SEVERAL VIEWS OF THE DRAWINGS

The herein described invention will be more fully understood from the detailed description given herein below and the accompanying drawings which should not be considered limiting to the invention described in the appended claims. The drawings are showing:

FIG. 1a shows schematically a heat recovery ventilation system in the heating mode, i.e., the normal mode according to an embodiment of the invention;

FIG. 1b shows the heat recovery ventilation system of FIG. 1a being switched into the defrosting mode, i.e., the reverse mode;

FIG. 2 shows a schematic view of the inside of a heat recovery ventilation unit as it can be used in an embodiment of the invention.

### DETAILED DESCRIPTION OF THE INVENTION

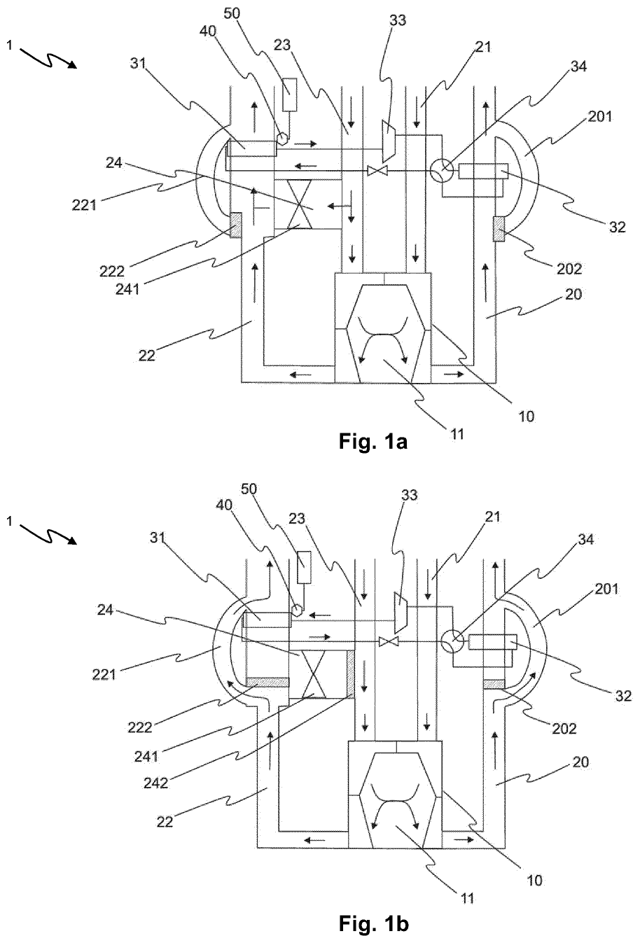

The heat recovery ventilation system 1 shown in FIG. 1a comprises heat recovery ventilation unit 10 with a heat exchanger 11 and an air source heat pump. The system shown operates in the heating mode, i.e., the normal mode. Fresh and cold outside air enters the outside air channel 23 and is delivered to heat recovery ventilation unit 10. Return air from inside the building, which is in particular during cold periods, i.e., winter, is delivered to the heat recovery ventilation unit 10 via return air channel 21. Within the heat exchanger 11, the outside air takes up thermal energy and optionally latent energy, i.e., moisture, from the return air, thereby being transformed to supply air, which has generally a higher thermal energy and optionally latent energy than the outside air. Vice versa, the return air delivers thermal energy and optionally latent energy to the outside air within the heat exchanger thereby being transformed into exhaust air, which has generally a lower thermal energy than the return air. The supply air then leaves the heat recovery ventilation unit 10 and is delivered into supply air channel 20. The exhaust air leaves the heat recovery ventilation unit 10 and is delivered into exhaust air channel 22. As both exhaust air channel bypass valve 222 and supply air channel bypass valve 202 are in the closed position, both evaporator bypass 221 and condenser bypass 201 are blocked. The supply air therefore passes condenser 32 of the air source heat pump and withdraws energy from the refrigerant of the air source heat pump which has been compressed in compressor 33 of the air source heat pump. This leads to an additional increase of thermal energy of the supply air, before it is being delivered to the inside of a building. Exhaust air 22 passes evaporator 31 of the air source heat pump upon which it delivers thermal energy to the condensed refrigerant. The refrigerant therefore evaporates and is delivered to the compressor as indicated by the arrow. The exhaust air has therefore suffered from a further decrease of thermal energy before it is being liberated to the outside of the building. In order to increase the performance of the air source heat pump a portion of the incoming outside air is directly fed via support channel 24 having support fan 241 to the exhaust air channel 22 without passing the heat recovery ventilation unit 10 (it is noted that support channel valve 242 is not shown in FIG. 1a for clarity purposes, see FIG. 1b). Sensor 40 further monitors a status of evaporator 31 being in general associated with the necessity to defrost the evaporator. The sensor may deliver an input parameter, being in general associated with the necessity to defrost the evaporator, to control unit 50. If the control unit registers by comparing the input parameter with a threshold value, that defrosting is required, it may switch four-way valve 34 in order to reverse the cycle of the air pressure heat pump such that the air recovery ventilation system 1 is switched into the defrosting mode, i.e., the reverse mode.

FIG. 1b shows the heat recovery ventilation system 1 of FIG. 1a in the defrosting mode. The exchange of thermal energy between the return air and the outside air within heat recovery ventilation unit 10 is the same as in FIG. 1a. However as can be seen by the arrows, the cycle of the air source heat pump has been reversed. The original evaporator 31 becomes therefore the defrosting mode condenser 31 and the original condenser 32 becomes the defrosting mode evaporator 32. In the defrosting mode, both the supply air channel bypass valve 202 and the exhaust air channel bypass valve 222 are in their open position. In this position, air flow through condenser bypass 201 and through evaporator bypass 221 is enabled, while air cannot pass original condenser 32, i.e., defrosting mode evaporator, and also not original evaporator 31, i.e., defrosting mode condenser. Thus, neither the supply air nor the exhaust air can essentially exchange thermal energy with the original condenser 32, i.e., defrosting mode evaporator, respectively with the evaporator 31, i.e., defrosting mode condenser. In addition, supply air channel valve 242 is in the closed position, which blocks supply air channel 24 and thus prevents that outside air can flow directly from outside air channel 23 to exhaust air channel 22 without passing heat recovery ventilation unit 10. In the defrosting mode, the cycle of the air source heat pump is reversed, i.e., original evaporator 31 acts as defrosting mode condenser, which means that the compressed refrigerant condenses and thus delivers thermal energy to the frozen original evaporator 31, which therefore defrosts much more rapidly. The condensed refrigerant is then delivered to original condenser 32, which acts now as defrosting mode evaporator and takes up thermal energy thereby evaporating before it is delivered to compressor 33 in which it is compressed again. Due to the open condenser bypass and the supply air channel bypass valve 202 blocking the passage via condenser 32, the loss of thermal energy of the supply air is avoided. After control unit 50 registers by comparing the input parameter of sensor 40 with a predefined target value that defrosting is complete it switches four-way valve 34 back to the normal mode, and also switches supply air channel bypass valve 202, exhaust air channel bypass valve 222 back in the closed position shown in FIG. 1a and support channel valve 241 back in the open position shown in FIG. 1a.

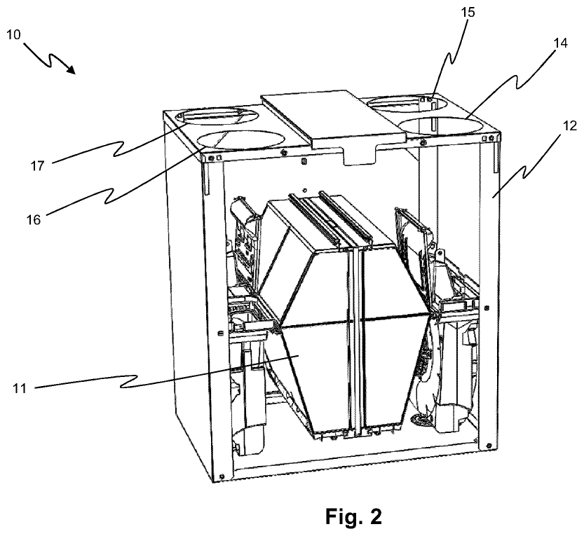

FIG. 2 shows a heat recovery ventilation unit 10, which can be used in an embodiment of the invention. Heat recovery ventilation unit 10 comprises unit housing 12 defining a unit compartment in which heat exchanger 11 is arranged. For clarity purposes, no tubing within the heat recovery ventilation unit is shown. Unit housing 12 has supply air outlet 14 which can be in fluidic communication with the supply air channel (see FIG. 1a), return air inlet 15, which can be in fluidic communication with the return air channel (see FIG. 1a), exhaust air outlet 16, which can be in fluidic communication with the exhaust air channel (see FIG. 1a) and outside air inlet 17, which can be in fluidic communication with the outside air channel (see FIG. 1a). The heat recovery ventilation unit further comprises two fans for providing the corresponding air flows.

1. A heat recovery ventilation system (1) for a building comprising:
a. a heat recovery ventilation unit (10) comprising a unit housing (12) having a supply air outlet (14), a return air inlet (15), an exhaust air outlet (16) and an outside air inlet (17), wherein the unit housing (12) defines a unit compartment, wherein a heat exchanger (11) is arranged within the unit compartment and wherein the heat exchanger (11) is configured such that thermal energy and optionally latent energy can be exchanged between outside air delivered via the outside air inlet (17) and return air delivered via the return air inlet (15);
b. a supply air channel (20) in fluidic connection with the supply air outlet (14) and configured for delivering supply air from the heat exchanger (11) to the inside of the building; a return air channel (21) in fluidic communication with the return air inlet (15) and configured for delivering return air from the inside of the building to the heat exchanger (11); an exhaust air channel (22) in fluidic communication with the exhaust air outlet (16) and configured for delivering exhaust air from the heat exchanger (11) to the outside of the building; an outside air channel (23) in fluidic communication with the outside air inlet (17) and configured for delivering outside air to the heat exchanger (11);
c. an air source heat pump comprising: an evaporator (31) configured for exchanging thermal energy with exhaust air in the exhaust air channel (22), a condenser (32) configured for exchanging thermal energy with supply air in the supply air channel (20), a compressor (33), an expansion valve and a four-way valve (34) configured for reversing the cycle of the air source heat pump from a normal mode to a defrosting mode;
wherein the exhaust air channel (22) comprises an evaporator bypass (221) bypassing the evaporator (31) and an exhaust air channel bypass valve (222) switchable between an open position in which exhaust air can flow through the evaporator bypass (221) and the exchange of thermal energy between exhaust air and the evaporator (31) is prevented, and a closed position in which exhaust air flow through the evaporator bypass (221) is prevented and the exchange of thermal energy between exhaust air and the evaporator (31) is possible; and
wherein the supply air channel (20) comprises a condenser bypass (201) bypassing the condenser (32) and a supply air channel bypass valve (202) switchable between an open position in which supply air can flow through the condenser bypass (201) and the exchange of thermal energy between supply air and the condenser (32) is prevented and a closed position in which supply air flow through the condenser bypass (201) is prevented and the exchange of thermal energy between supply air and the condenser (32) is possible.

2. The heat recovery ventilation system (1) according to claim 1, wherein the outside air channel (23) and the exhaust air channel (22) in fluidic connection with each other by a support channel (24) comprising a support fan (241) and configured for delivering a portion of outside air directly to the exhaust air channel (22).

3. The heat recovery ventilation system (1) according to claim 2, wherein the support channel (24) is connected with at least one of the exhaust air channel (22) upstream of the evaporator (31) and downstream of the exhaust air channel bypass valve (222).

4. The heat recovery ventilation system (1) according to claim 2, wherein the support channel (24) comprises a support channel valve (242) being switchable between an open position in which outside air can flow through the support channel (24) into the exhaust air channel (22) and a closed position in which outside air is prevented from flowing from the outside air channel (23) through the support channel (24) into the exhaust air channel (22).

5. The heat recovery ventilation system (1) according to claim 1, additionally comprising a temperature sensor and/or pressure sensor configured for monitoring a status of the evaporator (31).

6. The heat recovery ventilation system (1) according to claim 5, further comprising a control unit (50) configured for receiving an input parameter of the temperature sensor and/or pressure sensor, comparing the input parameter with a predefined threshold value and if the input parameter falls below or exceeds the predefined threshold value, switching the four-way valve (34) in order to reverse the cycle of the air source heat pump into the defrosting mode and switching the exhaust air channel bypass valve (222) and the supply air channel bypass valve (202) from the closed position into the open position.

7. The heat recovery ventilation system (1) according to claim 6, wherein the control unit (50) is configured for comparing the input parameter with a predefined target value and if the input parameter is equal to or above or below the predefined target value, switching the four-way valve (34) in order to reverse the cycle of the air source heat pump into the normal mode and switching the exhaust air channel bypass valve (222) and the supply air channel bypass valve (202) from the open position into the closed position.

8. A building comprising a heat recovery ventilation system (1) according to claim 1.

9. A method for operating a heat recovery ventilation system (1) for a building, in particular a heat recovery ventilation system (1) according to claim 1, the method comprising:
a. operating the heat recovery ventilation system (1) in a heating mode, the heating mode comprising:
providing outside air from the outside of the building via an outside air channel (23) to a heat exchanger (11) arranged in a unit compartment defined by a unit housing (12) of a heat recovery ventilation unit (10) through an outside air inlet (17) of the unit housing;
providing return air from the inside of the building via a return air channel (21) to the heat exchanger (11) through a return air inlet (15) of the unit housing (12);
transferring thermal energy and optionally latent energy from the return air to the outside air, thereby transforming the return air into exhaust air with decreased thermal energy and transforming the outside air into supply air with an increased thermal energy;
delivering the exhaust air from the heat exchanger (11) through an exhaust air outlet (16) of the unit housing (12) through an exhaust air channel (22) to the outside of the building, wherein thermal energy is transferred from the exhaust air to a refrigerant being arranged within an evaporator (31) of an air source heat pump, thereby evaporating the refrigerant;
compressing the evaporated refrigerant in a compressor (33) of the air source heat pump;
delivering the supply air from the heat exchanger (11) through a supply air outlet (14) of the unit housing (12) through a supply air channel (20) to the inside of building, wherein thermal energy is transferred from the compressed refrigerant within a condenser (32) of the air source heat pump to the supply air, thereby condensing the refrigerant;
b. switching the heat recovery ventilation system (1) from the heating mode to a defrosting mode by switching a four-way valve (34) of the air source heat pump into the defrosting mode in order to reverse the cycle of the air source heat pump, and by switching an exhaust air channel bypass valve (222) of the exhaust air channel (22) and supply air channel bypass valve (202) of the supply air channel (20) into the open position; and
c. operating the heat recovery ventilation system (1) in the defrosting mode, the defrosting mode comprising:
providing outside air from the outside of the building via the outside air channel (23) to the heat exchanger (11) through the outside air inlet (17) of the unit housing (12);
providing return air from the inside of the building via the return air channel (21) to the heat exchanger through the return air inlet (15) of the unit housing (12);
transferring thermal energy from the return air to the outside air, thereby transforming the return air into exhaust air with decreased thermal energy and transforming the outside air into supply air with an increased thermal energy;
delivering the supply air from the heat exchanger (11) through the supply air outlet (14) of the unit housing (12) through the supply air channel (20) and through a condenser bypass (201) of the supply air channel (20) bypassing the condenser (32) to the inside of building;
delivering the exhaust air from the heat exchanger (11) through the exhaust air outlet (16) of the unit housing (12) through the exhaust air channel (22) and through an evaporator bypass (221) of the exhaust air channel (22) bypassing the evaporator (31) to the outside of the building; and
defrosting the evaporator (31).

10. The method according to claim 9, wherein a temperature sensor and/or pressure sensor, monitors, at least periodically, a status of the evaporator (31) and provides a corresponding input parameter to a control unit (50), wherein the control unit (50) compares the input parameter with a predefined threshold value and wherein step b. is effected by the control unit (50) if the input parameter falls below or exceeds the predefined threshold value.

11. The method according to claim 10, wherein the control unit (50) switches the four-way valve (34) to reverse the cycle of the air source heat pump into the normal mode and switches the exhaust air channel bypass valve (222) and the supply air channel bypass valve (202) from the open position into the closed position, if the input parameter is equal to or above or below a predefined target value.

12. The method according to claim 9, wherein during step a. a portion of the outside air is delivered directly to the exhaust air channel (22) via a support channel (24) comprising a support fan (241).

13. The method according to claim 12, wherein during step b. a support channel valve (242) is switched from the open position to the closed position, thereby preventing outside air from flowing from the outside air channel (23) through the support channel (24) into the exhaust air channel (22).

14. Use of a heat recovery ventilation system (1) according to claim 1 for heating and/or cooling a building, and/or for providing outside air into a building.
